(19) United States
(12) Patent Application Publication
(10) Pub. No.: US 2013/0091206 A1
(43) Pub. Date: Apr. 11, 2013

(54) DISPLAYING SOCIAL NETWORK PLATFORM UPDATE DATA

(71) Applicants: Juliano Godinho Varaschin de Moraes, Mountain View, CA (US); Edward Ballot, Mountain View, CA (US); Eric Lovett, Palo Alto, CA (US); Andrew Long, (US); Andrew Grignon, Half Moon Bay, CA (US)

(72) Inventors: Juliano Godinho Varaschin de Moraes, Mountain View, CA (US); Edward Ballot, Mountain View, CA (US); Eric Lovett, Palo Alto, CA (US); Andrew Long, (US); Andrew Grignon, Half Moon Bay, CA (US)

(21) Appl. No.: 13/269,854

(22) Filed: Oct. 10, 2011

(51) Int. Cl. G06F 15/16

(52) U.S. Cl. 709/204

(57) ABSTRACT

Illustrated is a system and method to retrieve a list that includes at least one contact, from a social network platform. The system and method to build a contact object for the at least one contact, the contact object including an avatar representing the at least one contact. Additionally, the system and method to retrieve update data for the at least one contact object over a period of time. Further, the system and method to display the avatar and the update data associated with the at least one contact object.

### BACKGROUND

A social networking service is an online service, platform, or site that focuses on building and reflecting of social networks or social relations among people, who, for example, share interests and/or activities. A social network service essentially consists of a representation of each user (often a profile), his/her social links, and a variety of additional services. Most social network services are web based and provide means for users to interact over the Internet, such as e-mail and instant messaging. Social networking sites allow users to share ideas, activities, events, and interests within their individual networks.

One type of social network service is an aggregation service that aggregates a specific type of information from, for example, a number of users of a platform. This information may be updates that are posted by the users to the platform. Some popular updates are NEWSFEED™ feature that is part of the FACEBOOK™ platform (referenced herein as Facebook). This NEWSFEED™ feature allows users of Facebook to see a constant update list of their friends' Facebook activity. News Feed highlights updates that includes profile changes, upcoming events, and birthdays, among other updates.

### BRIEF DESCRIPTION OF THE DRAWINGS

Some embodiments of the invention are described, by way of example, with respect to the following figures:

FIG. 1 illustrates a mobile computing device, according to an example embodiment, that is used to display update data from any one of a number of sources while in exhibition mode.

FIG. 2 is a block diagram that illustrates a mobile computing device architecture, according to an example embodiment, enabled to be authenticated to a plurality of devices.

FIG. 3A is a diagram of a system, according to an example embodiment, for displaying update data on a mobile computing device, the mobile computing device in exhibition mode.

FIG. 3B is a side view of a system, according to an example embodiment, for displaying update data on a mobile computing device, the mobile computing device in exhibition mode.

FIG. 4 is a diagram of the mobile computing device, according to an example embodiment, in exhibition mode.

FIG. 5 is a block diagram of a system, according to an example embodiment, used to display update data from any one of a number of sources while a mobile computing device is in exhibition mode.

FIG. 6 is a block diagram of a system, according to an example embodiment, used to display update data from any one of a number of sources while a mobile computing device is in exhibition mode.

FIG. 7 is a flow chart illustrating a method, according to an example embodiment, used to display update data from any one of a number of sources while a mobile computing device in exhibition mode.

FIG. 8 is a flow chart illustrating a method, according to an example embodiment, executed by the exhibition mode logic to display update data from any one of a number of sources while a mobile computing device is in exhibition mode.

FIG. 9 is a flow chart illustrating a method, according to an example embodiment, to optionally filter the update data.

FIG. 10 is a flow chart illustrating the execution of a method, according to an example embodiment, in the form of a limited display function.

FIG. 11 is a flow chart illustrating the execution of a method, according to an example embodiment, in the form of an unlimited display function.

FIG. 12 is a flow chart illustrating the execution of a method, according to an example embodiment, to create a list of contact objects.

FIG. 13 is a flow chart illustrating the execution of a method, according to an example embodiment, to display contact objects.

### DETAILED DESCRIPTION

Illustrated is a system and method to generate a friend-wall view for social networks based upon the most recent updates and most recent friends. A friend-wall view is a graphically displayed matrix where each position in the matrix corresponds to a contact that is part of a social network. A contact may be represented as an avatar, image, or other suitable illustration presenting the contact. Collectively, these contact representations are referenced herein as avatars. Updates may be provided via an Application Programming Interface (API) to a social networking platform, and/or via any one of a number of sources such as a Simple Message Service (SMS) feed, a Multimedia Messaging Service (MMS) feed, an RDF Site Summary (RSS) feed, a web feed, an email feed, or some other suitable feed of updated data. Updates are referred to herein as update data. Example social networks include FACEBOOK™, LINKEDIN™, TWITTER™, and GOOGLE+™.

In some example embodiments, a User Interface (UI) and associated algorithm is disclosed by which the UI in the form of a displayed matrix is populated with update data. The algorithm is responsible for identifying the most active contacts/friends and displaying the latest updates data from those friends in an exhibition-type view. As used herein, an exhibition-type view is a display of images on a display of a mobile computing device, where the mobile computing device is currently inactive or hibernating. This mode may be manifested on the display of the mobile computing device where there is little human interaction with the mobile computing device, and/or the mobile computing device is being charged with electrical power. An example UI is depicted as follows:
1. A representation of friends/contacts in a unique view that shows an avatar for each of them, organized as a grid/matrix view that the avatars are animated into.
2. A background process responsible for showing updates from one or more social networks on the display requiring little or no user interaction.
   An example implementation of the method includes the following:
1. Calculate how many contacts are needed to form a matrix filling the whole display, considering the device display size.
2. If there are fewer contacts then the number needed to fill the display, then duplicate the existing contacts until there are enough to fill the wall.
3. If there are more contacts than are needed to fill the display, then determine which friends are the most active ones and remove non-active friends until there are exactly the number needed to fill the display.
4. Retrieve the most recent updated data (“news feed” updates) associated with these friends. These updates can be text, photo or video from a friend/contact.
5. Using a pre-defined time interval, cycle through these updates, showing each update near the contact in the matrix and highlighting the contact.
6. Repeat steps 1 through 5 on a time interval to guarantee that new updates are continually shown.
   Update data, as used herein, may include a posting to a social networking site, a message (e.g., instant messaging or otherwise), a like message/notation, a Uniform Resource Locator (URL) based link, an image, an email, and a date and time associated with the update data.

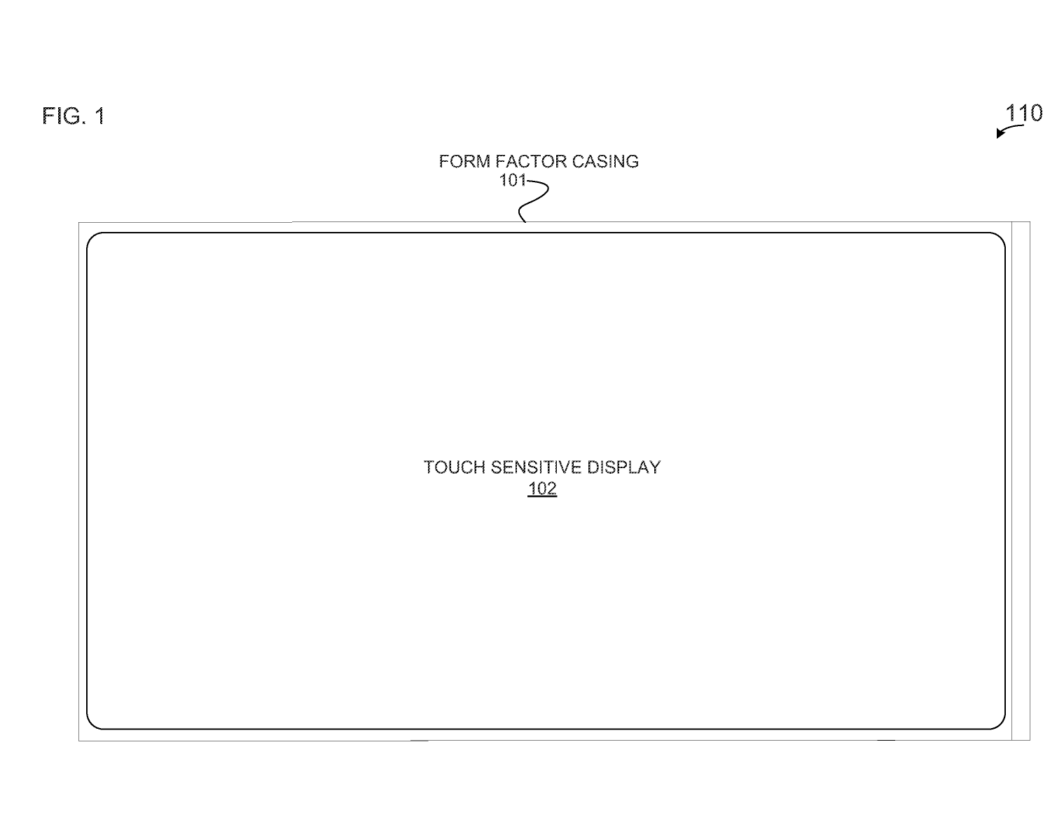

FIG. 1 illustrates one embodiment of a mobile computing device 110 that is used to display update data from any one of a number of sources while in exhibition mode. As shown, this mobile computing device 110 includes a touch-sensitive display 102. The mobile computing device 110 may be a tablet device, smart phone, portable computer, or other suitable computing device capable of wireless connectivity over a voice or data network. The display 102 of the mobile computing device 110 is, for example, a 240×240, a 320×320, a 320×480, or a 640×480 touch sensitive (including gestures) display screen. The display 102 can be structured from, for example, such as glass, plastic, thin-film or composite material. In one embodiment the screen may be 1.5 inches to 9.7 inches (or 4 centimeters to 25 centimeters) diagonally. The touch sensitive display may be a transflective liquid crystal display (LCD) screen. In alternative embodiments, the aspect ratios and resolution may be different without departing from the principles of the inventive features disclosed within the description. By way of example, embodiments of the display 102 comprises an active matrix liquid crystal display (AMLCD), a thin-film transistor liquid crystal display (TFT-LCD), an organic light emitting diode (OLED), an Active-matrix OLED (AMOLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive infra-red)) including a digitizer for receiving input data, commands or information from a user. The user may use a stylus, a finger or another suitable input device for data entry, such as selecting from a menu or entering text data.

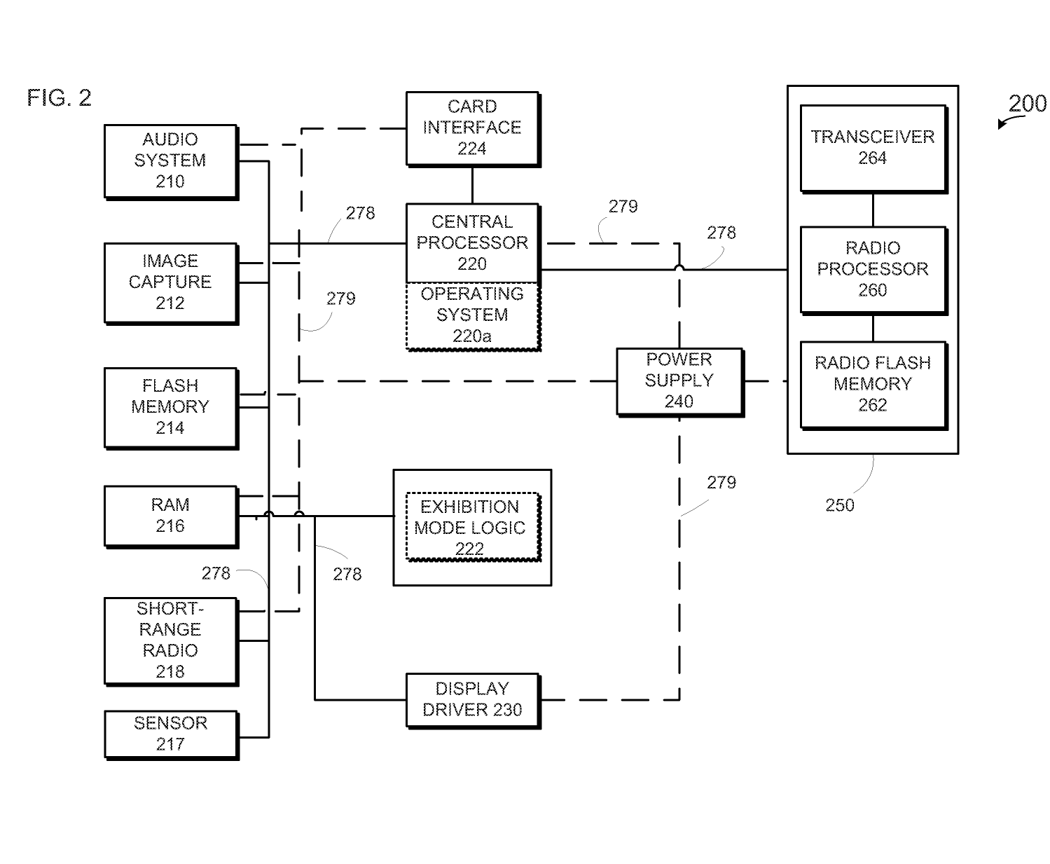

Referring next to FIG. 2, a block diagram illustrates an example architecture of a mobile computing device 110, enabled to be authenticated to a plurality of devices. By way of example, the architecture illustrated in FIG. 2 will be described with respect to the mobile computing device of FIG. 1. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, QUALCOMM SNAPDRAGON, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system 220a. The operating system 220a is an interface between hardware and an application, with which a user typically interfaces. The operating system 220a is responsible for the management and coordination of activities and the sharing of resources of the mobile computing device 110. The operating system 220a provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE 8), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11, 802.20, 802.15, 802.16)). The central processor 220 communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279. The power supply 240 may include at least one coil to facilitate inductive charging and data transfer.

The central processor communicates with applications executing within the mobile computing device 110 through the operating system 220a. In addition, intermediary components, for example, an exhibition logic module 222 provides additional communication channels between the central processor 220 and operating system 220a and system components, for example, the display driver 230. As will be discussed in more detail below, the exhibition logic module 222 is used to display update data from any one of a number of sources.

It is noted that in one embodiment, central processor 220 executes logic (e.g., by way of programming, code, or instructions) corresponding to executing applications interfaced through, for example, the display 102. It is noted that numerous other components and variations are possible to the hardware architecture of the computing device 200, thus an embodiment such as shown by FIG. 2 is just illustrative of one implementation for an embodiment.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the mobile computing device 110, e.g., an antenna, where communication signals are received from an established call (e.g., a connected or on-going call). The received communication signals include voice (or other sound signals) received from the call and processed by the radio processor 260 for output through the speaker 120. The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone of the mobile computing device 110, (or other sound signals) that is processed by the radio processor 260 for transmission through the transmitter of the transceiver 264 to the established call.

In one embodiment, communications using the described radio communications may be over a voice or data network. Examples of voice networks include GSM communication system, a CDMA system, and UMTS. Examples of data networks include General Packet Radio Service (GPRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot, The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

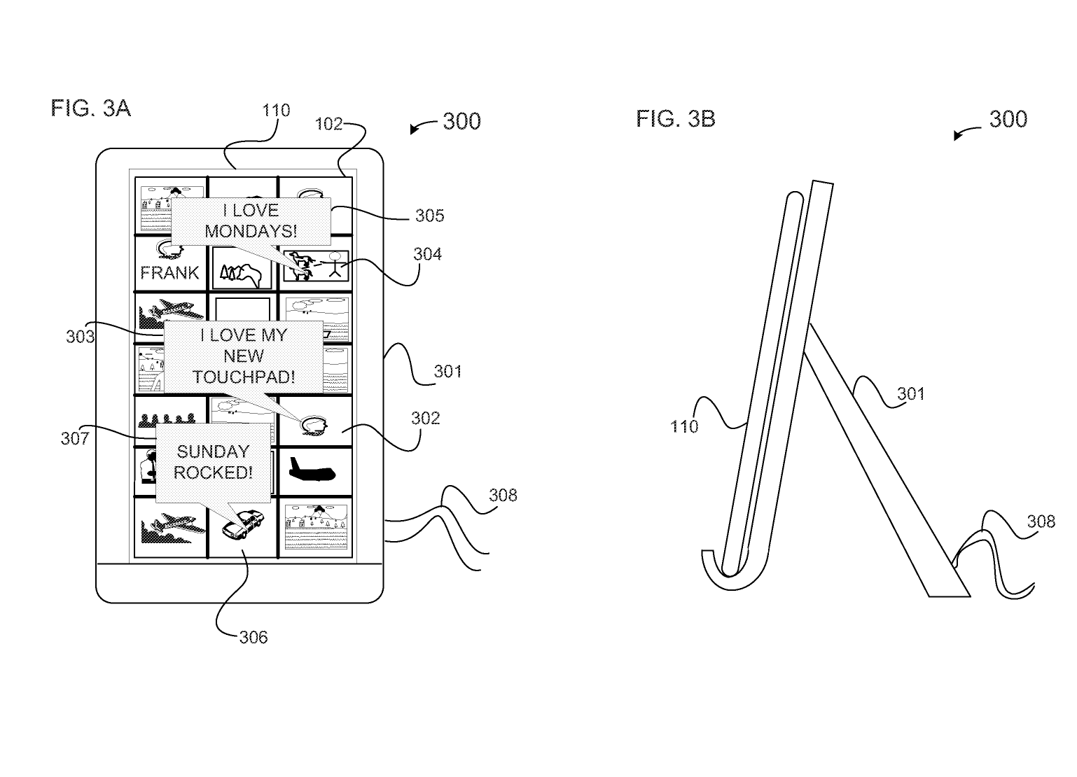

FIG. 3A is a diagram of a system 300 for displaying update data on a mobile computing device 110, the mobile computing device 110 in exhibition mode. Shown is a mobile computing device 110 operatively connected to a docking station 301. An example of this docking station 301 is provided by U.S. patent application Ser. No. 13/170,847 filed on Jun. 28, 2011 and titled “Docking Station For Portable Computing Devices,” which is incorporated by reference in its entirety. A power cord 308 may be used to provide electrical power to the docking station 301. Shown on the display 102 is a friend-wall view that is a graphically displayed matrix where each position in the matrix corresponds to a contact that is part of a social network. Example positions 302, 304, and 306 in the matrix are illustrated. Associated with each of these positions 302, 304, and 306 is a contact. Further, associated with each contact is update data such that position 302 has associated with it update data 303, position 304 has update data 305, and position 306 has update data 307. In some example embodiments, the update data 303, 305 and 307 is displayed as a text box popup, and reflects that most recent posting of data on a social networking site by the contact.

FIG. 3B is a side view of a system 300 for displaying update data on a mobile computing device 110, the mobile computing device 110 in exhibition mode. Shown is the mobile computing device 110 operatively connected to the docking station 301. Electrical power is provided to the docking station via the power cord 308. In some example embodiments, the mobile computing device 110 is inductively charged by the docking station 301.

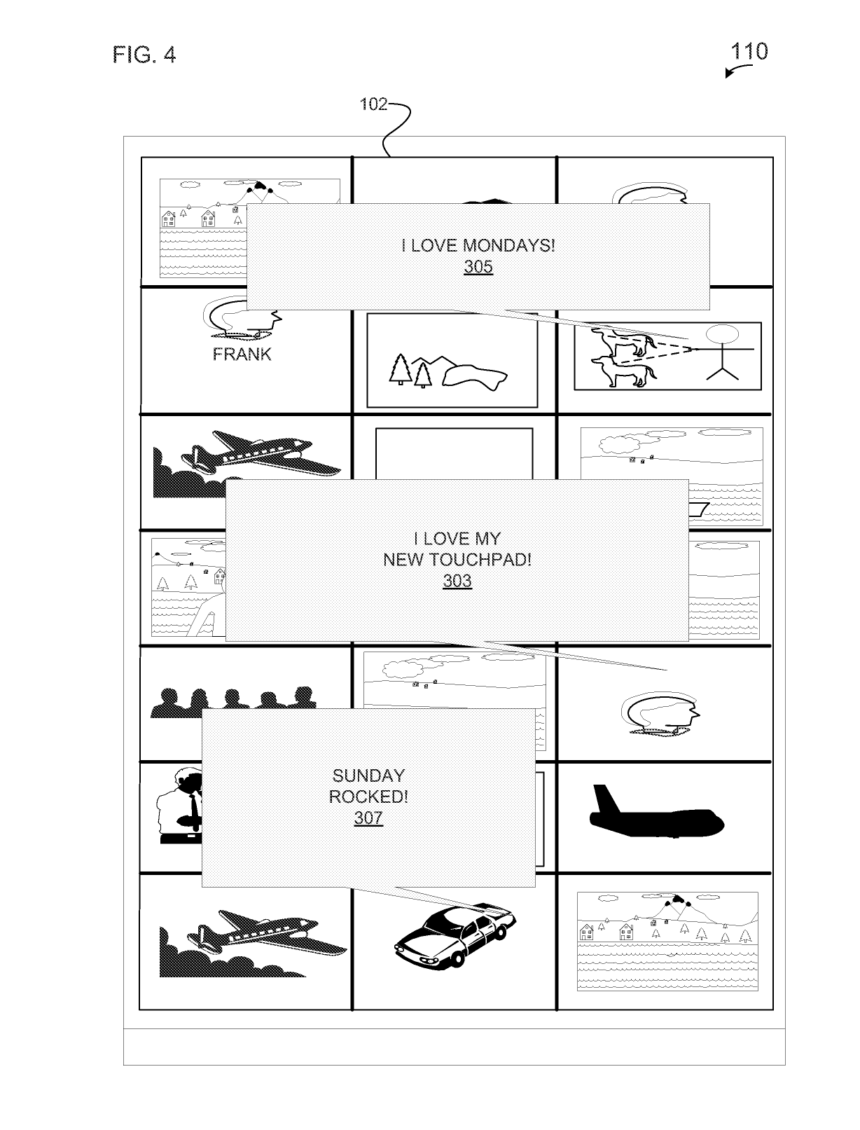

FIG. 4 is a diagram of the mobile computing device 110 in exhibition mode. Shown is the display 102 showing update data 303, 305 and 307 is displayed as a text box popup, and reflects that most recent posting of data on a social networking site by the contact. The use of a text box popup is for illustrative purposes and may be replaced by a text box that has a transparent background such that the contacts are visible behind the text of the text box.

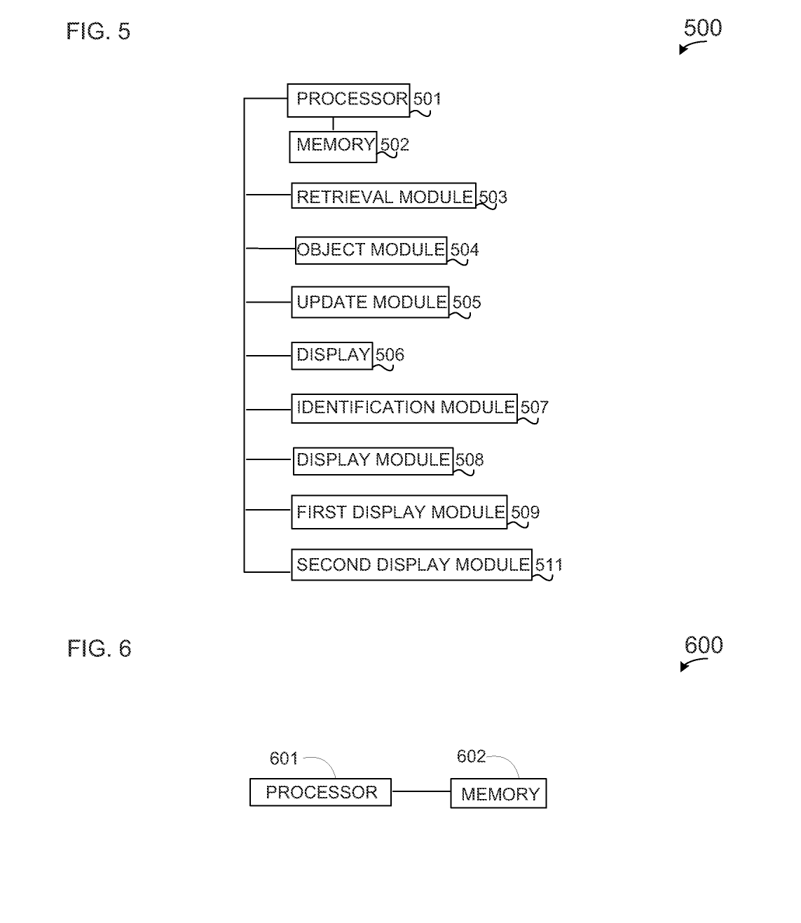

FIG. 5 is a block diagram of an example system 500 used to display update data from any one of a number of sources while a mobile computing device 110 is in exhibition mode. The various blocks shown herein may be implemented in software, hardware, or firmware. These blocks may be operatively connected, where operatively connected includes a physical or logical connection. Shown is a processor 501 operatively connected to a memory 502. Operatively connected to the processor 501 is a retrieval module 503 executed to retrieve a list, that includes at least one contact, from a social network platform. Operatively connected to the processor 501 is an object module 504 executed to build a contact object for the at least one contact, the contact object including an avatar representing the at least one contact. Operatively connected to the processor 501 is an update module 505 to retrieve update data for the at least one contact object over a period of time. Operatively connected to the processor 501 is a display 506 to show the avatar and the update data associated with the at least one contact object. An example of the display 506 is the display 102. Operatively connected to the processor 501 is an identification module 507 to identify a plurality of avatars that includes the avatar associated with the at least one contact object. The processor 501 is executed to calculate a number of avatars, from the plurality of avatars, needed to form a matrix that fills a display, the calculating based upon a size of the display. Operatively connected to the processor 501 is a display module 508 to determine there are fewer avatars then needed to fill the display, and duplicating the avatars until the display is filled. Operatively connected to the processor 501 is a first display module 509 to determine there are more avatar then needed to fill the display. Operatively connected to the processor 501 is a second display module 510 to determine which contact objects associated with which avatars are most active and removing non-active avatars until there are a number of avatars identified to fill the display 506. In some example embodiments, most active includes a largest amount of update data over the period of time as compared to another contact object. In some example embodiments, non-active includes a lesser amount of update data over the period of time as compared to another contact object.

FIG. 6 is a block diagram of an example system 600 used to display update data from any one of a number of sources while a mobile computing device 110 is in exhibition mode. The various blocks shown herein may be implemented in software, hardware, or firmware. These blocks may be operatively connected, where operatively connected includes a physical or logical connection. Shown is a processor 601 operatively connected to a memory 602. The memory 602 is in communication with the central processor 601, the memory 602 including logic encoded in one or more tangible media for execution and when executed operable to retrieve a list, that includes at least one contact, from a social network platform, build a contact object for the at least one contact, the contact object to include an avatar representing the at least one contact, retrieve update data for the at least one contact object over a period of time and display the avatar and the update data associated with the at least one contact object. Additionally, the memory 602 includes logic encoded in one or more tangible media for execution and when executed operable to identify a plurality of avatars that includes the avatar associated with the at least one contact object, calculate a number of avatars, from the plurality of avatars, needed to form a matrix that fills a display, the calculating based upon a size of the display, and determine there are fewer avatars then needed to fill the display, and duplicate the avatars until the display is filled. Further, the memory 602 includes logic encoded in one or more tangible media for execution and when executed operable to identify a plurality of avatars that includes the avatar associated with the at least one contact object, calculate a number of avatars, from the plurality of avatars, needed to form a matrix that fills a display, the calculating based upon a size of the display, determine there are more avatar then needed to fill the display, and determine which contact objects associated with which avatars are most active and removing non-active avatars until there are a number of avatars identified to fill the display. In some example embodiments, most active includes a largest amount of update data over the period of time as compared to another contact object. In some example embodiments, non-active includes a lesser amount of update data over the period of time as compared to another contact object.

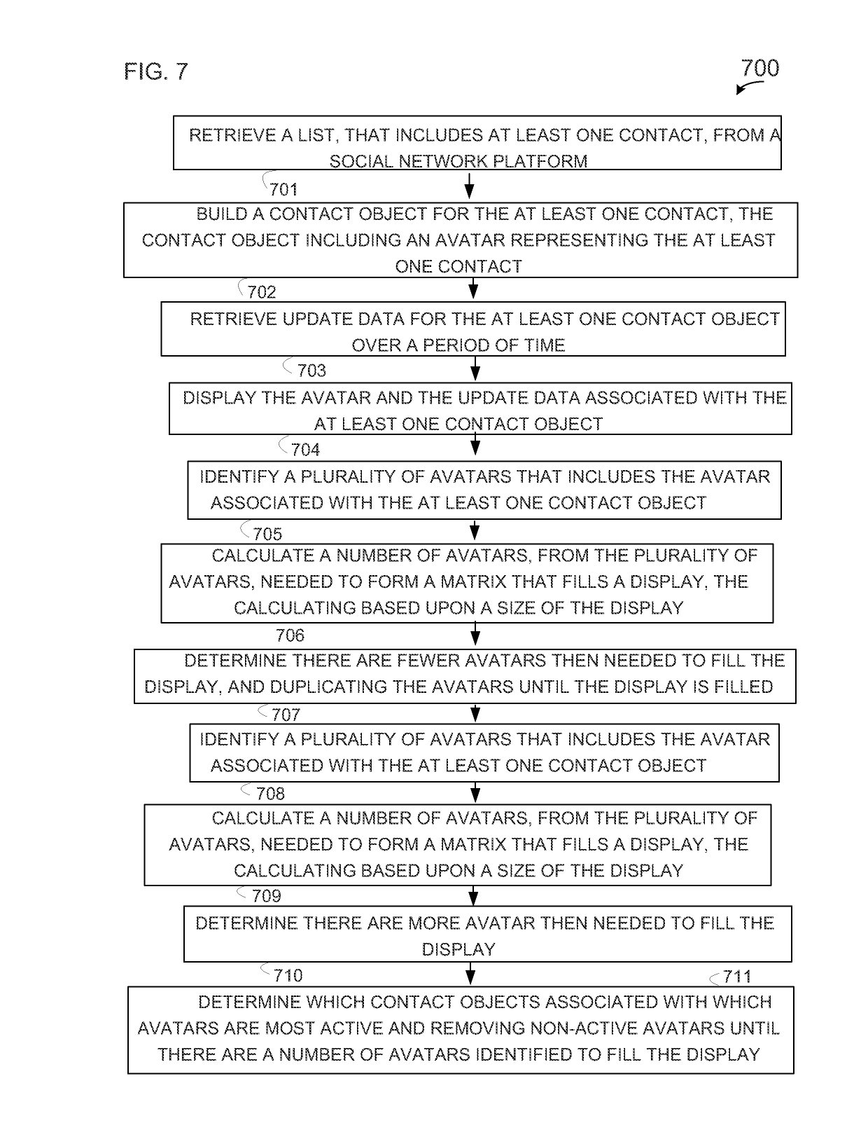

FIG. 7 is a flow chart illustrating an example method 700 used to display update data from any one of a number of sources while a mobile computing device 110 in exhibition mode. Operations 701-711 may be executed as part of the exhibition mode logic 222. Operation 701 is executed to retrieving a list, that includes at least one contact, from a social network platform. Operation 702 is executed to build a contact object for the at least one contact, the contact object including an avatar representing the at least one contact. Operation 703 is executed to retrieve update data for the at least one contact object over a period of time. Operation 704 is executed to display the avatar and the update data associated with the at least one contact object. Operation 705 is executed to identify a plurality of avatars that includes the avatar associated with the at least one contact object. Operation 706 is executed to calculate a number of avatars, from the plurality of avatars, needed to form a matrix that fills a display, the calculating based upon a size of the display. Operation 707 is executed to determine there are fewer avatars then needed to fill the display, and duplicating the avatars until the display is filled. Operation 708 is executed to identify a plurality of avatars that includes the avatar associated with the at least one contact object. Operation 709 is executed to calculate a number of avatars, from the plurality of avatars, needed to form a matrix that fills a display, the calculating based upon a size of the display. Operation 710 is executed to determine there are more avatars then needed to fill the display. Operation 711 is executed to determine which contact objects associated with which avatars are most active and removing non-active avatars until there are a number of avatars identified to fill the display. In some example embodiments, most active includes a largest amount of update data over the period of time as compared to another contact object. In some example embodiments, non-active includes a lesser amount of update data over the period of time as compared to another contact object.

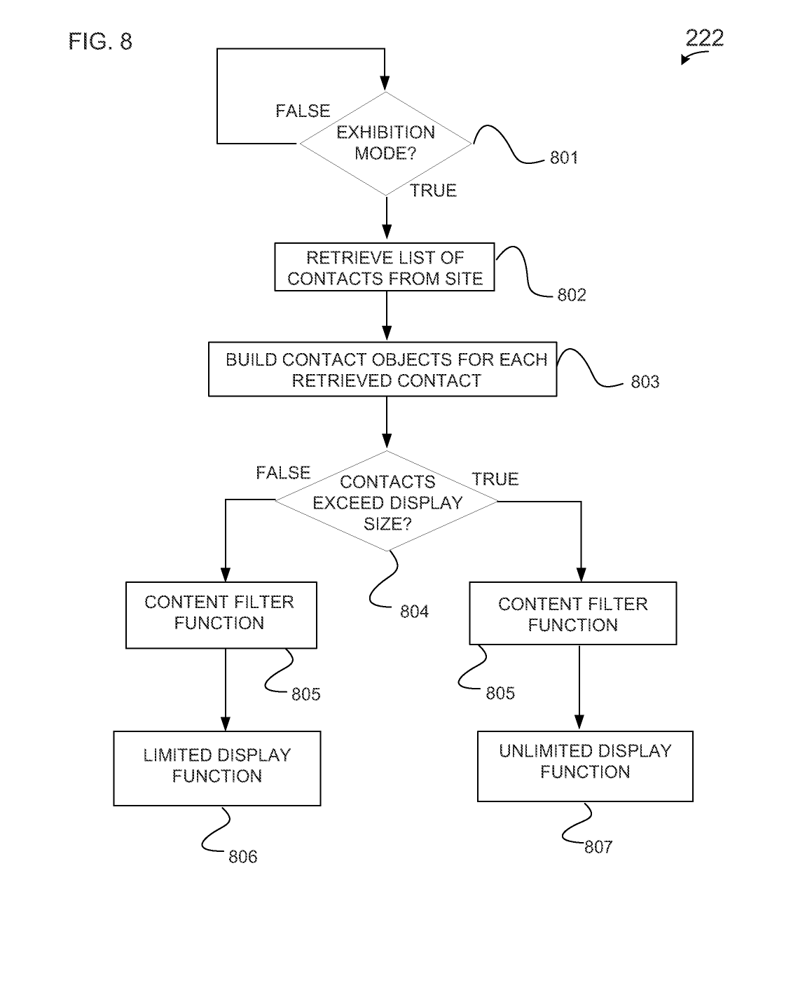

FIG. 8 is a flow chart illustrating an example method executed by the exhibition mode logic 222 to display update data from any one of a number of sources while a mobile computing device 110 is in exhibition mode. Shown is a decision operation 801 that is executed to determine whether the mobile computing device 110 is in exhibition mode. In cases where decision operation 801 evaluates to “false”, the decision operation 801 is re-executed. In cases where decision operation 801 evaluates to “true”, operation 802 is executed. Operation 802 is executed to retrieve a list of contacts from a social networking site. Operation 803 is executed to build contact objects for each of the retrieved contacts. An example contact object class definition is provided as follows—

enyo.kind({

name: “User”,
kind: enyoKind.Component,
published: {

userId: “”,
fullName: “”,
firstName: “”,
lastName: “”,
picSmall: “”,
picSquare: “”

},
events: {

onUserDataLoaded: “”,
onUserDataLoadedError: “”

})

A decision operation 804 is shown that determines whether the contacts exceed the display size. For example, if the display 102 has an area of 51 cm², and each contact takes up an area of 1 cm², then roughly 50 contacts may be placed onto the display 102. If there are more than 50 contacts, then those contact that have most recently posted updated data may be given priority. If decision operation 804 evaluates to “false”, operation 805 is executed. If decision operation 804 evaluates to “true”, operation 805 is executed. Operation 805 is executed to optionally filter the content (i.e., the updated data). Operation 806 is executed to provide a limited display function for processing the contacts where they are less than the display size. Operation 807 is executed to provide an unlimited display function, where the number of contacts exceeds the display size.

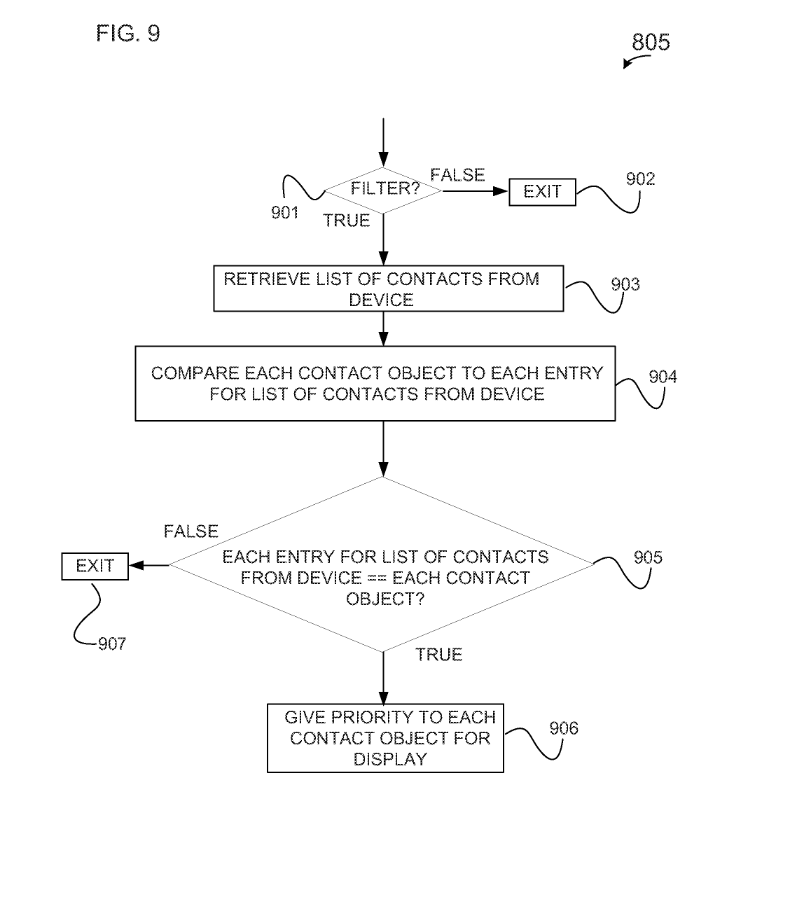

FIG. 9 is a flow chart illustrating an example method 805 to optionally filter the update data. Shown is a decision operation 901 to determine whether to filter the update data. The determination may be user initiated or event initiated. In cases where decision operation 901 evaluates to “false”, a termination operation 902 is executed to exit the method 805. In cases where the decision operation 901 evaluates to “true”, an operation 903 is executed. Operation 903 is executed to retrieve a list of contacts from a device. This list of contacts may be retrieved from a Subscriber Identity Module (SIM) card, or other contact list that is used to facilitate telephony based communications. Operation 904 is executed to compare each contact object to each entry in a contact list for the mobile computing device 110. A decision operation 905 is executed to determine whether each entry for a list of contacts from a device is equivalent to each contact object. In some example embodiments, equivalency is determined based upon a comparison of the name field of each contact in the list to the contact object class and the name field(s) associated with this object. Example name fields include “User”, “userID”, “full name”, “first name”, and/or “last name”. In cases where decision operation 905 evaluates to “true”, operation 906 is executed. In cases where decision operation 905 evaluates to “false”, an operation 907 is executed that serves as a termination condition.

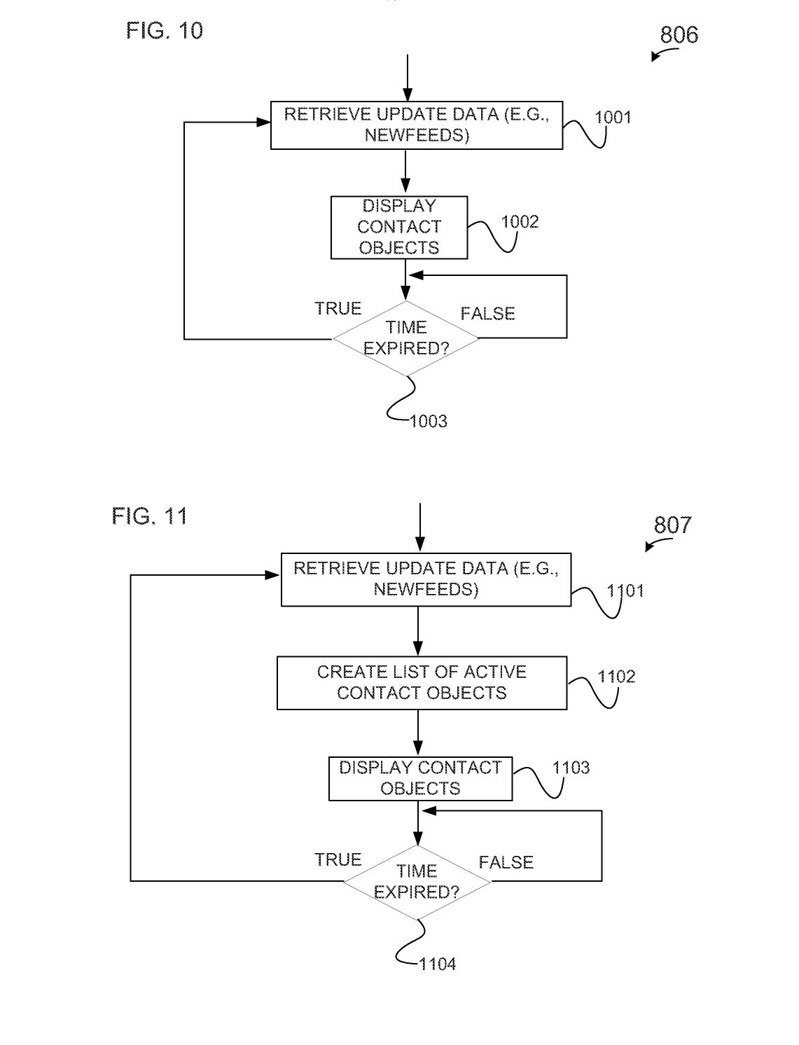

FIG. 10 is a flow chart illustrating the execution of an example method 806 in the form of a limited display function. Shown is an operation 1001 to retrieve updates. In some example embodiments, these updates are retrieved using an API supplied by a social networking platform. Operation 1002 is executed to display contact objects. Decision operation 1003 is executed to determine whether time has expired. Time, as used herein, may be a preset numeric value in the form of 5 seconds, 10 seconds, one minute, or some other suitable measurement of time. In cases where decision operation 1003 evaluates to “true”, an operation 1001 is executed. In cases where decision operation 1003 evaluates to “false”, decision operation 1003 is re-executed.

FIG. 11 is a flow chart illustrating the execution of an example method 807 in the form of an unlimited display function. Shown is an operation 1101 executed to retrieve updates. Updates may retrieved from a social networking platform using APIs provided by the platform. The following example object class definition may be used in retrieving updates via an API—

enyo.kind({

name: “Post”,
kind: “Observable”,
events: {

onFailure: “”,
onSuccess: “”,
onLikeCommentChanged: “”

},
published: {

serverData: undefined,
profilePicSrc: “”,
messageIndexed: “”,
// from Facebook API
postId : “”,
fromName: “”,
fromId: “”,
toList: [ ],
message: “”,
picture: “”,
link: “”,
postName: “”,
caption: “”,
description: “”,
icon: “”,
type: “”,
createdTime: “”,
updatedTime: “”,
attribution: “”,
likesCount: 0,
commentsCount: 0,

An example of an update is the FACEBOOK™ NEWSFEED™ update. Operation 1102 is executed to create a contact list of active contact objects. In some example embodiments, this list is a priority queue or some other suitable data structure. Operation 1103 is executed to display contact objects. Decision operation 1104 is executed to determine whether time has expired. In cases where decision operation 1104 evaluates to “true”, an operation 1101 is re-executed. In cases where decision operation 1104 evaluates to “false”, decision operation 1104 is re-executed.

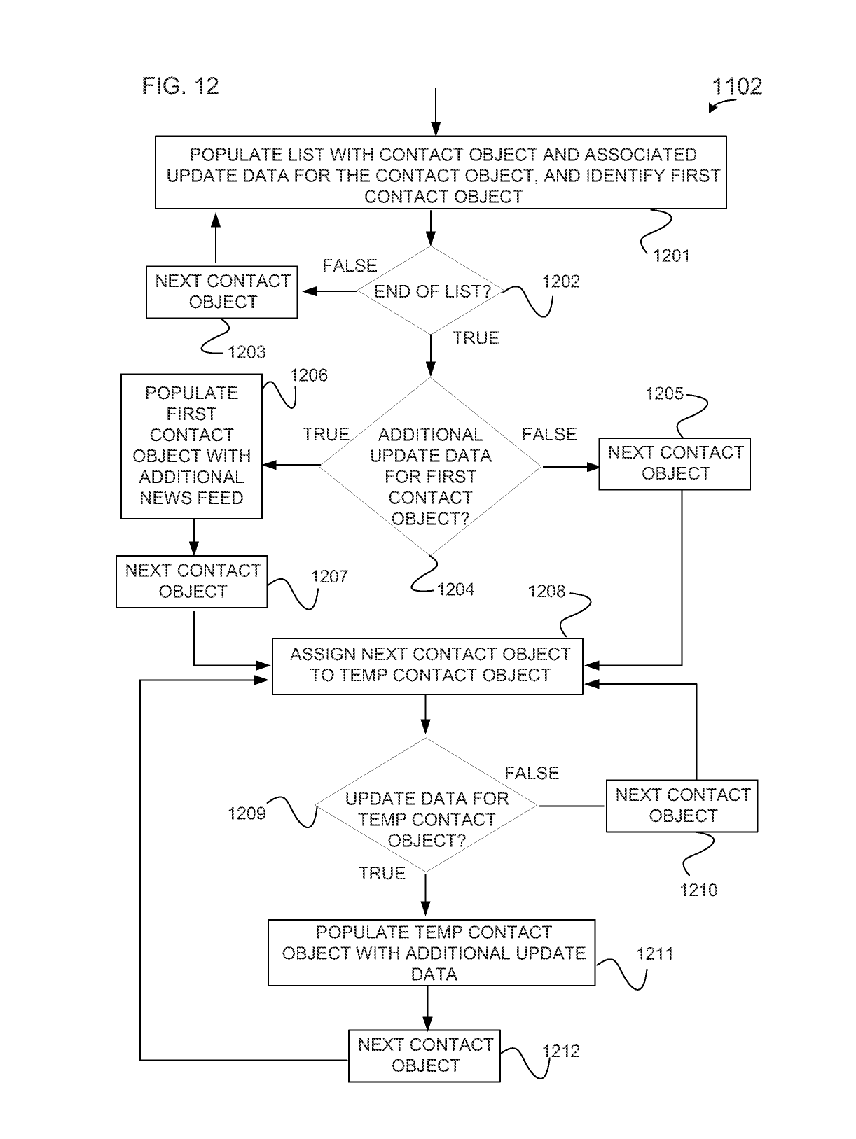

FIG. 12 is a flow chart illustrating the execution of the example method 1102 to create a list of contact objects. Illustrated is an operation 1201 executed to populate a list (e.g., priority queue or some other suitable data structure) with contact objects and associate update data with these contact objects. Contact objects may be instantiated from the above illustrated contact object class. Further, this operation 1201 is executed to identify the head of the list (i.e., the first contact object in the list). Decision operation 1202 is executed to determine whether the end of the list has been encountered. This end of the list can be identified as a pointer to a null value (Ø) as may be encountered in a list such as a priority queue, or even another suitable data structure such as a tree. In cases where decision operation 1202 evaluates to “false”, an operation 1203 is executed that traverses the list to the next contact object and associated position in the list. This traversal may be via a pointer, an index value, or other suitable mechanism. In cases where decision operation 1202 evaluates to “true”, an additional decision operation 1204 is executed. Decision operation 1204 is executed to determine whether there is an additional update for the first contact object. In cases where decision operation 1204 evaluates to “true”, an operation 1206 is executed. In cases where decision operation 1204 evaluates to “false”, an operation 1205 is executed. Operation 1206 is executed to populate the first contact object with an additional news feed (i.e., update data). Operation 1207 is executed to traverse to the list to the next position in the list. Similarly, operation 1205 is executed to again traverse to the list to the next position. Operation 1208 is executed to assign the next contact object to a temporary (“temp.”) contact object. A decision operation 1209 is executed to determine the update data for the temp. contact object. In cases where decision operation 1209 evaluates to “false”, an operation 1210 is executed to traverse to the list to the next position in the list. In cases where decision operation 1209 evaluates to “true”, operation 1211 is executed. Operation 1211 is executed to populate the temp. contact object with additional update data. Operation 1212 is executed to traverse to the list to the next position in the list.

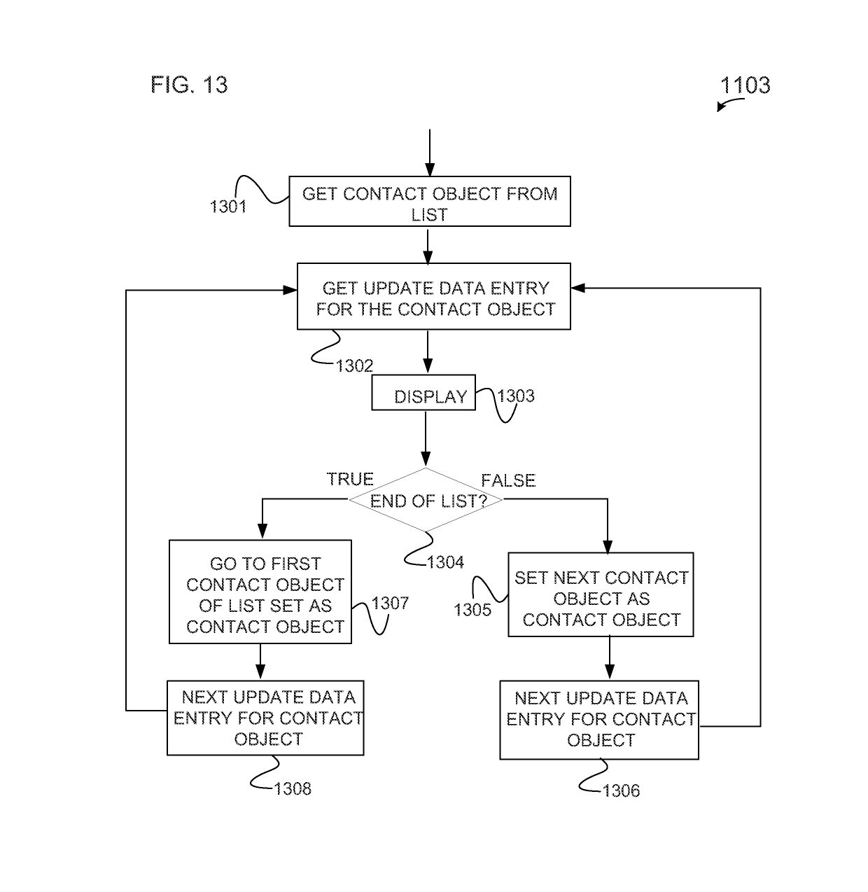

FIG. 13 is a flow chart illustrating the execution of an example method 1103 to display contact objects. Shown is an operation 1301 that is executed to get contact objects from a list (e.g., the example list illustrated of FIGS. 11 and 12). Operation 1302 is executed to get the update data entry for the contact object. Operation 1303 is executed to display the updated data at, for example, position 302 as update data 303, or at position 304 as update data 305, or at position 306 as update data 307. A decision operation 1304 is executed to determine whether the end of the list has been encountered. In cases where decision operation 1304 evaluates to “true”, an operation 1307 is executed. In cases where decision operation 1304 evaluates to “false”, an operation 1305 is executed. Operation 1307 is executed to go to the first contact object, and set this as the contact object for which to get update data (see operation 1302). Operation 1308 is executed to get the next update data entry for the contact object. Operation 1305 is executed to set the next contact object as the contact object. Operation 1306 is executed to get the next update data entry for the contact object.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

1-15. (canceled)

16. A computer-implemented method comprising:
determining that a mobile computing device is in an exhibition mode;
retrieving a list of contacts from a social networking site using the mobile computing device;
building a contact object for each retrieved contact included in the list of contacts; and
displaying the contact object.

17. The computer-implemented method of claim 16, further comprising:
retrieving a list of contacts from the mobile computing device, the list of contacts stored to a Subscriber Identity Module (SIM) card;
comparing the contact object to each entry in the list of contacts; and
giving priority to the contact object for display.

18. The computer-implemented method of claim 16, wherein the exhibition mode is a exhibition type view that includes at least one of inactivity and hibernation.

19. The computer-implemented method claim 16, wherein the contact object is built from an object class definition that includes at least one of a first name, last name, and userID.

20. The computer implemented method of claim 16, further comprising retrieving update data from the social networking site.

21. A mobile-computing device comprising:
at least one processor;
a memory in communication with the at least one processor, the memory including logic encoded in one or more tangible media for execution and when executed operable to:
retrieve a list that includes at least one contact from a social network platform, the list retrieved while the mobile-computing device is in exhibition mode;
build a contact object for the at least one contact, the contact object to include an avatar representing the at least one contact;
retrieve update data for the at least one contact object over a period of time; and
display the avatar and the update data associated with the at least one contact object.

22. The mobile-computing device of claim 21, further comprising the memory in communication with the at least one processor, the memory including logic encoded in one or more tangible media for execution and when executed operable to:
identify a plurality of avatars that includes the avatar associated with the at least one contact object;
calculate a number of avatars, from the plurality of avatars, needed to form a matrix that fills a display, the calculating based upon a size of the display; and
determine there are fewer avatars then needed to fill the display, and duplicate the avatars until the display is filled.

23. The mobile-computing device of claim 21, further comprising the memory in communication with the at least one processor, the memory including logic encoded in one or more tangible media for execution and when executed operable to:
identify a plurality of avatars that includes the avatar associated with the at least one contact object;
calculate a number of avatars, from the plurality of avatars, needed to form a matrix that fills a display, the calculating based upon a size of the display;
determine there are more avatar then needed to fill the display; and
determine which contact objects associated with which avatars are most active and removing non-active avatars until there are a number of avatars identified to fill the display.

24. The mobile-computing device of claim 21, wherein most active includes a largest amount of update data over the period of time as compared to another contact object.

25. The mobile-computing device of claim 23, wherein non-active includes a lesser amount of update data over the period of time as compared to another contact object.

26. A mobile-computing device in exhibition mode comprising:
a retrieval module to retrieve a list, that includes at least one contact, from a social network platform;
an object module to build a contact object for the at least one contact, the contact object including an avatar representing the at least one contact;
an update module to retrieve update data for the at least one contact object over a period of time; and
a display to show the avatar and the update data associated with the at least one contact object.

27. The mobile-computing device in exhibition mode of claim 26, further comprising:
an identification module to identify a plurality of avatars that includes the avatar associated with the at least one contact object;
a processor to calculate a number of avatars, from the plurality of avatars, needed to form a matrix that fills a display, the calculating based upon a size of the display; and
a display module to determine there are fewer avatars then needed to fill the display, and duplicating the avatars until the display is filled.

28. The mobile-computing device in exhibition mode of claim 26, further comprising:
an identification module to identify a plurality of avatars that includes the avatar associated with the at least one contact object;
a processor to calculate a number of avatars, from the plurality of avatars, needed to form a matrix that fills a display, the calculating based upon a size of the display;
a first display module to determine there are more avatar then needed to fill the display; and
a second display module to determine which contact objects associated with which avatars are most active and removing non-active avatars until there are a number of avatars identified to fill the display.

29. The mobile-computing device in exhibition mode of claim 28, wherein most active includes a largest amount of update data over the period of time as compared to another contact object.

30. The mobile-computing device in exhibition mode of claim 28, wherein the mobile computing device is inductively charged by a docking station.
